(19) United States
(12) Patent Application Publication
(10) Pub. No.: US 2007/0245391 A1
(43) Pub. Date: Oct. 18, 2007

(54) System and method for an end-to-end IP television interactive broadcasting platform

(76) Inventor: Dalton Pont, Sterling, VA (US)

Correspondence Address: FREDERICK BAILEY, 11317 NANCYANN WAY, FAIRFAX, VA, 22030, US

(21) Appl. No.: 11/727,235

(22) Filed: Mar. 26, 2007

Related U.S. Application Data
(60) Provisional application No. 60/786,011, filed on Mar. 27, 2006.

(51) Int. Cl. H04N 7/173

(52) U.S. Cl. 725/113; 725/109; 725/112

(57) ABSTRACT

An IP-based television interactive broadcast system that includes: a first subsystem, the first subsystem receiving and storing raw content arriving from a content generation source; a second subsystem, the second subsystem processing the received content by performing at least one of encoding, editing, inserting interactive modules into the content, or inserting special affects and graphics in the received content, and a third subsystem, the third subsystem having the capability to stack multiple streaming files into a playlist, store all of the processed content from the second subsystem, broadcast, control access, and manage the delivery of streams/channels to worldwide audiences. The IP-based television interactive broadcast system capable of delivering an unlimited number of channels containing multiple content, where the channels are interactive 2-way streams contained within a single IP Internet session. The worldwide audiences are able to interact with the content as well as with others viewing the content.

This application claims the benefit of U.S. Provisional Patent Application No. 60/786,011, filed Mar. 27, 2006, the content of which is expressly incorporated by reference herein in its entirety.

### BACKGROUND

1. Field of the Invention

This invention is related to broadcasting content, and more specifically to end-to-end IP-based television interactive broadcasting.

2. Description of the Related Art

Content owners typically place content onto a media server which streams media to the Internet, usually though embedded code on a web server that is accessed by consumers via a web browser. This is normally a one stream-to-one website link configuration, and is normally a short video clip or maybe even a longer stream consisting of one show or movie. There are advertisement insertion tools for a single channel or stream. There are many other various forms of single channel or single stream solutions available today. Also, there are video servers that can manage multiple streams to multiple viewers (multi-sessions), on-demand streaming servers.

Therefore, there is a need for a system and method for end-to-end IP television interactive broadcasting that enables delivery of channels containing multiple content and where the channels are interactive (2-way) streams contained within a single IP Internet session.

### SUMMARY OF THE INVENTION

A system and method for an end-to-end IP television interactive broadcasting platform that integrates hardware, software, network technologies, and a novel process into a multi-channel 24/7 IPTV interactive broadcasting platform. The IP-based television interactive broadcast system includes: a first subsystem, the first subsystem receiving and storing raw content arriving from a content generation source; a second subsystem, the second subsystem processing the received content by performing at least one of encoding, editing, embedding interactive modules, or inserting special affects and graphics in the received content; and a third subsystem, the third subsystem having the capability to stack multiple streaming files into a playlist, store all of the processed content from the second subsystem, broadcast, control access, seek external content sources, and manage the delivery of streams/channels to worldwide audiences in an interactive fashion. The end-to-end IP television interactive broadcasting enables delivery of unlimited channels over a public network such as the Internet containing multiple content, where the channels are interactive 2-way streams contained within a single IP Internet session.

### BRIEF DESCRIPTION OF THE DRAWINGS

The present invention is further described in the detailed description which follows in reference to the noted plurality of drawings by way of non-limiting examples of embodiments of the present invention in which like reference numerals represent similar parts throughout the several views of the drawings and wherein:

FIG. 1 is a diagram of a system for end-to-end IP-based television interactive broadcasting according to an example embodiment of the present invention;

FIG. 2 is a diagram a diagram of a system for end-to-end IP-based television broadcast interaction showing various content providers according to an example embodiment of the present invention;

FIG. 3 is a flowchart of a process in an IP-based television interactive broadcast system according to an example embodiment of the present invention;

FIG. 4 is a diagram of an IP-based television interactive broadcast system according to an example embodiment of the present invention;

FIG. 5 is a diagram of an ingest subsystem according to an example embodiment of the present invention;

FIG. 6 is a diagram of a content management subsystem according to an example embodiment of the present invention;

FIG. 7 is a diagram of a delivery management subsystem according to an example embodiment of the present invention;

FIG. 8 is a diagram of an IP-based television interactive broadcast multi-layered architecture according to an example embodiment of the present invention;

FIG. 9 is a diagram of a first example screen on an interactive GUI of a user's computer in an IP-based television interactive broadcast system according to an example embodiment of the present invention;

FIG. 10 is a diagram of a second example screen on an interactive GUI of a user's computer in an IP-based television interactive broadcast system according to an example embodiment of the present invention;

FIG. 11 is a diagram of a third example screen on an interactive GUI of a user's computer in an IP-based television interactive broadcast system according to an example embodiment of the present invention;

FIG. 12 is a functional block diagram of an IP-based television interactive broadcast system with interactive features according to an example embodiment of the present invention; and

FIG. 13 is a diagram of software components that use a service-oriented architecture (SOA) to enable an IP-based television interactive broadcast system according to an example embodiment of the present invention.

### DETAILED DESCRIPTION

The particulars shown herein are by way of example and for purposes of illustrative discussion of the embodiments of the present invention. The description taken with the drawings makes it apparent to those skilled in the art how the present invention may be embodied in practice.

Further, arrangements may be shown in block diagram form in order to avoid obscuring the invention, and also in view of the fact that specifics with respect to implementation of such block diagram arrangements is highly dependent upon the platform within which the present invention is to be implemented, i.e., specifics should be well within purview of one skilled in the art. Where specific details (e.g., circuits, flowcharts) are set forth in order to describe example embodiments of the invention, it should be apparent to one skilled in the art that the invention can be practiced without these specific details. Finally, it should be apparent that any combination of hard-wired circuitry and software instructions can be used to implement embodiments of the present invention, i.e., the present invention is not limited to any specific combination of hardware circuitry and software instructions.

Although example embodiments of the present invention may be described using an example system block diagram in an example host unit environment, practice of the invention is not limited thereto, i.e., the invention may be able to be practiced with other types of systems, and in other types of environments.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Embodiments of the present invention relate to methods and systems for an end-to-end IP television interactive broadcasting platform that integrate hardware, software, network technologies, and a novel process into a multi-channel 24/7 IPTV broadcasting platform. This system and method of operation enables many content owners/producers to broadcast many channels of unlimited content over the Internet. Similar to a cable system, embodiments of the present invention in the form of an interactive broadcast platform (system & process) deliver many TV quality channel options to homes and businesses, but delivered over an IP network. The channels are true TV quality channels, with the normal advertisements, graphics, audio, transitions, TV guides, and other normal TV characteristics. The unique integration of components and processes enable the delivery of channels containing multiple content (shows, wrap ads, pop-up ads, third party content, interactive IP traffic, etc.) as a single channel (media fusion). In addition to media fusion, channels according to embodiments of the present invention are interactive (2-way) streams contained within a single IP Internet session. Also, just like any Internet connection, users can open multiple concurrent channels at any given time (many windows or multiple picture-in-picture (PIP) windows). Systems according to embodiments of the present invention enable targeting advertisements and include high assurance viewer statistics. These statistics come from actually knowing how many viewers there are, what channels they have viewed, how long they viewed each channel, etc., and are actual recorded measures as opposed to Nielsen and Arbitron ratings that are a predictive sampling and contain some uncertainty.

Embodiments of the present invention may use a platform that may consist of an integrated system and business process. The integrated system may be composed of one or more subsystems. To help illustrate the present invention, an example embodiment will be used where the system is composed of three subsystems. Each subsystem may consist of multiple processors that can be scaled to support growth to thousands of channels. However, embodiments according to the present invention are not limited to a system with three subsystems but may include any system architecture that is within the spirit and scope of the present invention.

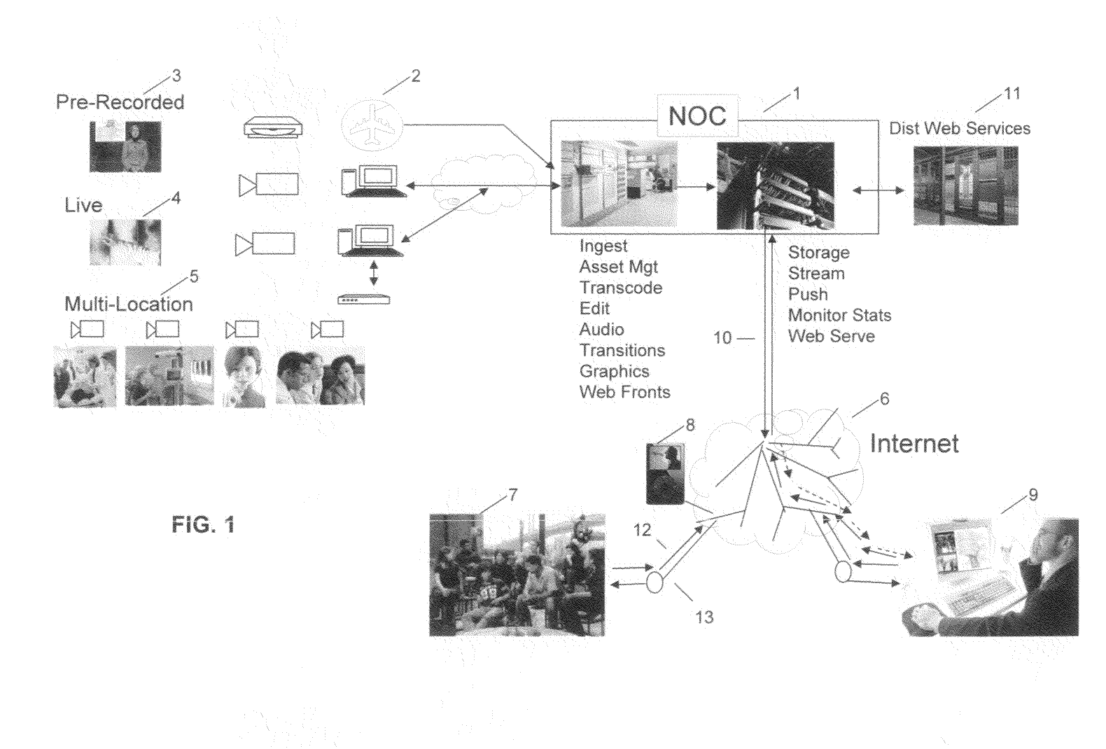

FIG. 1 shows a diagram of a system for end-to-end IP-based television interactive broadcasting according to an example embodiment of the present invention. To help illustrate the present invention, platforms according to the present invention will be referred to as a Network Operations Center (NOC) 1. An NOC X may receive various types of content from a variety of sources 2. The content may be pre-recorded content 3, live content 4, or a mix thereof. Further, the content may be from multiple locations 5. Content may be received from one or more sources such as, for example, via physical delivery, the Internet 6, a portable or non-portable electronic device, or from a wired or wireless network that may include a router.

The NOC may include various content processing capabilities (further details follow) such as, for example, content ingest, asset management, content transcoding, content editing, audio processing, transitions, graphics, web fronts, content storage, content steaming, pushing of content, statistics monitoring, web server, etc. After receipt and processing of the content by the NOC, the processed content may then be distributed to various requesting sources 7-9 over the Internet 6 and/or over one or more content delivery networks (CDN) 10. The requesting sources may include, for example, a terminal using a web browser 9, a PDA, an Apple iPod 8, a group of users 7, etc. The requesting sources may issue an IPTV broadcast request or an on-demand request, for example, and receive an IPTV stream or an on-demand stream, respectively, in response. The requesting source may also access content by typing in a universal resource locator (URL). The NOC 1 may also communicate with distributed web services 11. Requests 12 for content may be initiated by the requesting sources 7-9 and in response, appropriate content distributed 13 from the NOC 1 to the requesting sources 7-9. The requests may include requests for on-demand content and/or IPTV broadcast content.

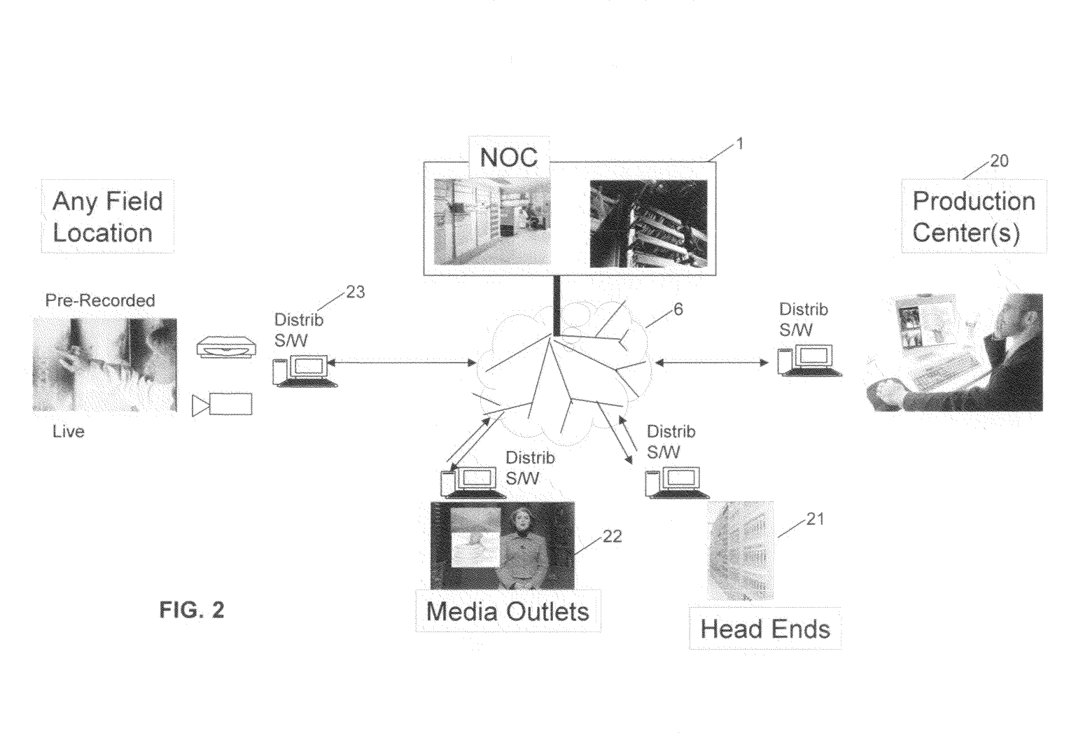

FIG. 2 shows a diagram a diagram of a system for end-to-end IP-based television interactive broadcasting showing various content providers according to an example embodiment of the present invention. As noted previously, an NOC embodiment according to the present invention may receive content from a variety of content owner/producer sources. For example, content may be received from productions centers 20, head ends 21, media outlets 22 such as radio and television stations, and/or from a content owner/producer that provides pre-recorded content and/or live content. Preferably each content owner/producer has digital content distribution software 23 installed on their workstations/servers that allows a content provider to move/transmit live or pre-recorded content.

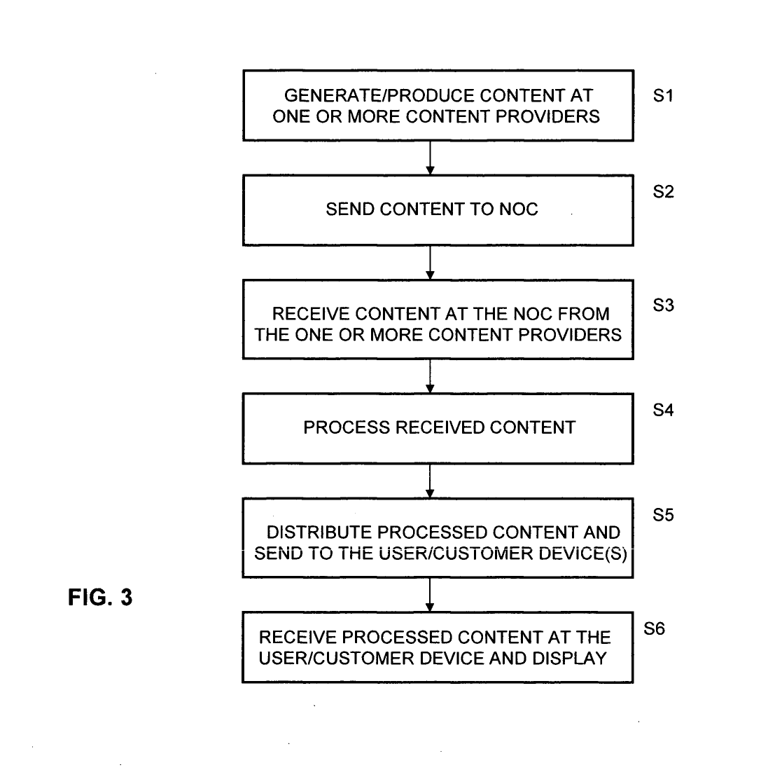

FIG. 3 is a flowchart of a process in an IP-based television interactive broadcast system according to an example embodiment of the present invention. Content is generated or produced at one or more content providers (S1). The content may be live content or pre-recorded content. The content is sent to a network operations center (S2). Alternatively, the content may be retrieved by the NOC. The content may be sent or retrieved over a public network such as the Internet. The content is received by NOC from the one or more content providers (S3). The content may be received by one or more devices capable of receiving various types of content including pre-recorded content and live content. The content may be received by devices and/or software that allows self-loading of the content from the content provider, thus allowing quick checkout of the received content, quality control of the received content and movement of the received content directly to the processors/servers for processing.

The received content is then processed by one or more processors or servers (S4). The processor/servers are capable of performing various types of processing on the content such as, for example, encoding the content, editing the content, inserting special effects into the content, inserting advertisements into the content, inserting links to other content into the content, inserting graphics into the content, etc. During processing, the content may be displayed on a set of panoramic monitors that allow an administrator to manage the receiving and processing of multiple streams of content simultaneously. The content being processed and the final processed content may be stored in storage devices at the NOC.

The processed content may then be distributed and sent to the user device (S5). The processed content is sent to user devices using a private network and a public network by one or more processors/servers. Preferably, the private network comprises a content delivery network (CDN) and the public network comprises the Internet. The processor/servers are capable of performing various post processing functions such as, for example, stacking multiple streaming files into a playlist, storing all of the processed content, broadcasting the processed content, controlling access to the processed content, and managing the delivery of the processed content in streams/channels to user devices worldwide. The distributed processed content or content being processed may be displayed on a big screen monitor at the NOC that is visible to a group of individuals.

The processed content is then received at the user/customer device and displayed (S6). The content may be displayed at the user device in the form of a website graphical user interface (GUI) with multiple windows or areas and selectable icons. The selectable icons may provide the user of the device the ability to select options related to the content, select other content, access other functions, or have an interactive session with other users, or persons related to the content.

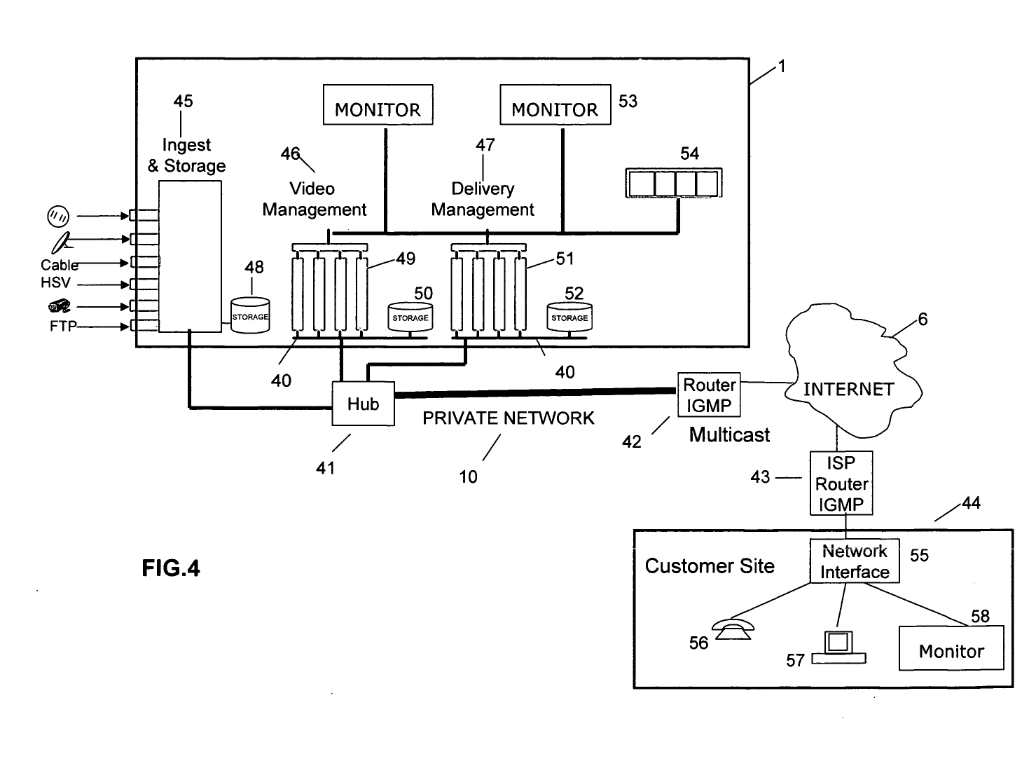

FIG. 4 is a diagram of an IP-based television interactive broadcast system according to an example embodiment of the present invention. The system may include a NOC 1 with an internal network bus 40, at least one hub 41, at least one private network 10, at least one router 42, a second network such as the Internet 6, an ISP router 43, and a customer site 44. An NOC 1 according to embodiments of the present invention may include different subsystems 45-47 that each performs different functions.

A first subsystem 45 may be an ingest subsystem and may consist of one or more processors (not shown) that may share an arrayed storage 48 used to receive and store raw content arriving from one or more content owners/producers. Preferably, each processor is capable of performing the same functions. Thus, the first subsystem may be expanded/reduced as needed depending on increased/decreased system requirements without impacting current operations of the subsystem, thus providing easy scalability.

Content may be received via any of many possible sources such as, for example, a DVD device, directly from a camera, from a cable stream, from a satellite stream, from an analog source, or any other source. Preferably, the content is received from content providers over the Internet via a File Transfer Protocol (FTP). Embodiments of the present invention may include a unique FTP web tool that simplifies part of the process. This tool contains a content self-loading feature that allows content providers to use an FTP site to deliver their content directly into platforms according to the present invention allowing quick checkout, quality control of the content after receipt at the platform and movement directly into the broadcast processing. This simplifies the processing and shortens the processing cycle by avoiding having to move files or content from various storages devices such as DVDs, tapes, portable digital devices, etc.

A second subsystem 46 may be a video or content management subsystem. The second subsystem 46 may consist of one or more processors or servers 49, each loaded with video editing and coding software, and a storage array 50. Preferably, each processor 49 is capable of performing the same functions. Thus, the second subsystem 46 may be expanded/reduced as needed depending on increased/decreased system requirements without impacting current operations of the subsystem, thus providing easy scalability. The second subsystem 46 has the ability to receive content for editing/clipping and other content processing purposes. For example, the second subsystem 46 may be capable of encoding content, editing content, adding special effects and graphics to content, and performing other content “finishing” touches. Special tags and other markers may be used to insert web actions (play advertisement, pop advertisement, launch third party website in an adjacent frame, etc.) into the content in this subsystem 46. This subsystem 46 may also create the web interface (“look and feel” of the channel) presented to a user and link all of the content needed for the channel.

A third subsystem 47 may be a delivery subsystem that may consist of one or more processors or servers 51. The one or more processors 51 may run media server software and web server software. The software provides the capability to stack multiple streaming files into a playlist, which will launch the designated web actions as planned. The software may use also instructions, scripts, codes, etc. to broadcast, control access, and to manage the delivery of the streams/channels to audiences worldwide. Preferably, each processor 51 is capable of performing the same functions. Thus, the third subsystem 47 may be expanded/reduced as needed depending on increased/decreased system requirements without impacting current operations of the subsystem, thus providing easy scalability. The third subsystem 47 may also include one or more storage devices 52 to hold finished video, advertisements, websites, etc. that may be inserted into distributed content or a playlist. The delivery management system 47 may be directed to multicast channels, or content can be available on-demand, or content can be delivered via PushTV, a technique where designated channels pre-stage or cache some content on the viewers' machines prior to viewing.

In an NOC 1 according to embodiments of the present invention, the processors, servers, and storage devices of the first subsystem 45, second subsystem 46 and third subsystem 47 may be interconnected via an internal network bus 40. Further, the NOC 1 may include one or more large big screen displays/monitors 53, and one or more groups of panoramic monitors 54 useable by administrators to receive, process and distribute content.

The internal network bus 40 may be connected to a hub 41 for distribution of one or more channels of content to one or more users. The hub 41 may be connected to another network 10 that is connected to one or more routers 42 that multicasts the one or more channels of content using the Internet 6 or other network to one or more customer sites 44 via one or more ISP routers 43. The hub 41 may be connected to the one or more routers via a private network 10. Preferably, the private network is a high speed, high capacity network, e.g., DS3 or higher, and may be owned by an outside entity such as a company or organization. Further, preferably, the router 42 is located in close proximity to the customer site receiving the content. A private network 10 provides advantages over directly connecting to the Internet 6 by getting the data closer to the user quickly before then putting the data on a public network such as the Internet 6. A private network 10 increases speed, provides better quality, and is more reliable than the Internet 6 where the number of hops and routers the content travels cannot be controlled. By using a private network 10, e.g. a CDN, content is more efficiently transferred to users and the disadvantages of transmission over the Internet 6 are minimized. The first subsystem 45, second subsystem 46 and third subsystem 47 may also be individually connected to the hub 41 without the internal network bus 40.

A customer site 44 may include a network interface 55 that may be interconnected to a number of devices such as, for example, a computer 57, a telephone 56, a monitor 58, etc. The computer 57 may be connected to the Internet 6 via the network interface 55, a telephone line or any other means via wired or wireless technology. Although, a customer site 44 shown may include the various above items, embodiments of the present invention are not limited to this type of customer site. A customer site may be any user device capable of accessing a public network, such as, for example, a computer, a Personal Digital Assistant (PDA), a mobile phone, an iPod, a monitor, etc.

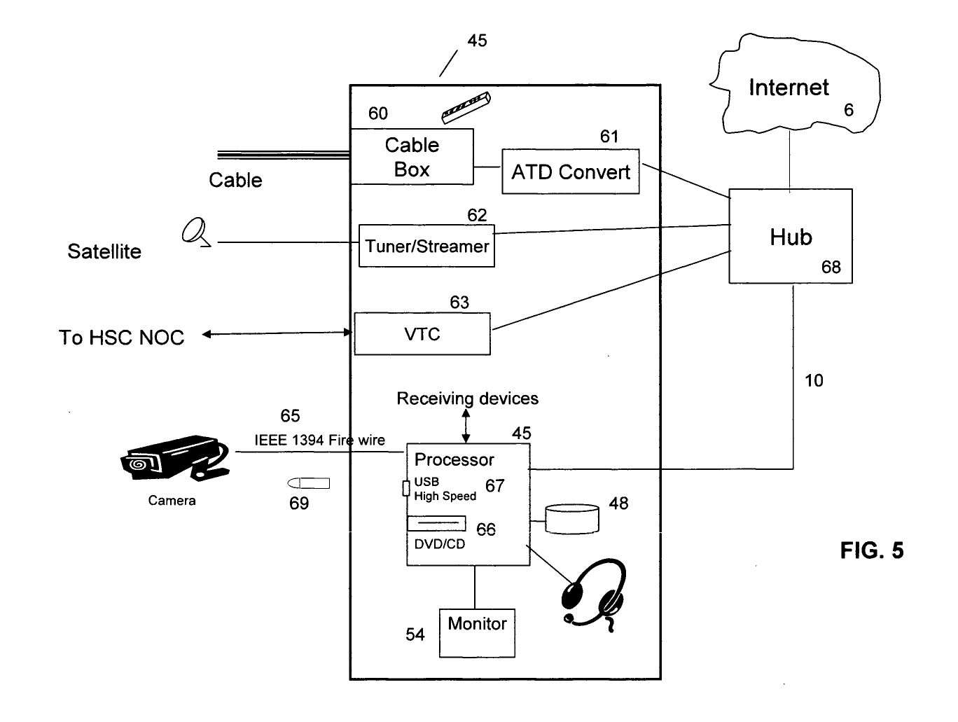

FIG. 5 is a diagram of an ingest subsystem according to an example embodiment of the present invention. The ingest subsystem 45 may include receiving devices with the capability to receive content in different forms and from various sources. For example, the ingest subsystem 45 may include a cable box 60, an analog-to-digital converter 61, a tuner/streamer 62 capable of receiving content from satellites, any video teleconferencing (VTC) node 63, at least one processor or server 64, etc. These devices may also receive content sent over the Internet 6 through a hub 68 (which may be the same or different from the hub 41 distributing content). The processors/servers 64 have capabilities for receiving different types of content such as, for example, a Fire wire interface 65, a DVD/CD player 66, USB high speed interface 67 for attaching to USB devices 69, etc., and also may be connected to one or more monitors 54 and one or more storage devices 48 for storing the received raw data content. The processor/server 64 may contain software to aid in receiving content such as, for example, IP Capture software, archive software, File Transfer Protocol (FTP) software, camcorder software, DVD software, CD software, etc. from the receiving devices 61-63, and may provide control for these devices. The ingest subsystem 45 may also be connected to the Internet 6, through a hub 41 and CDN 10.

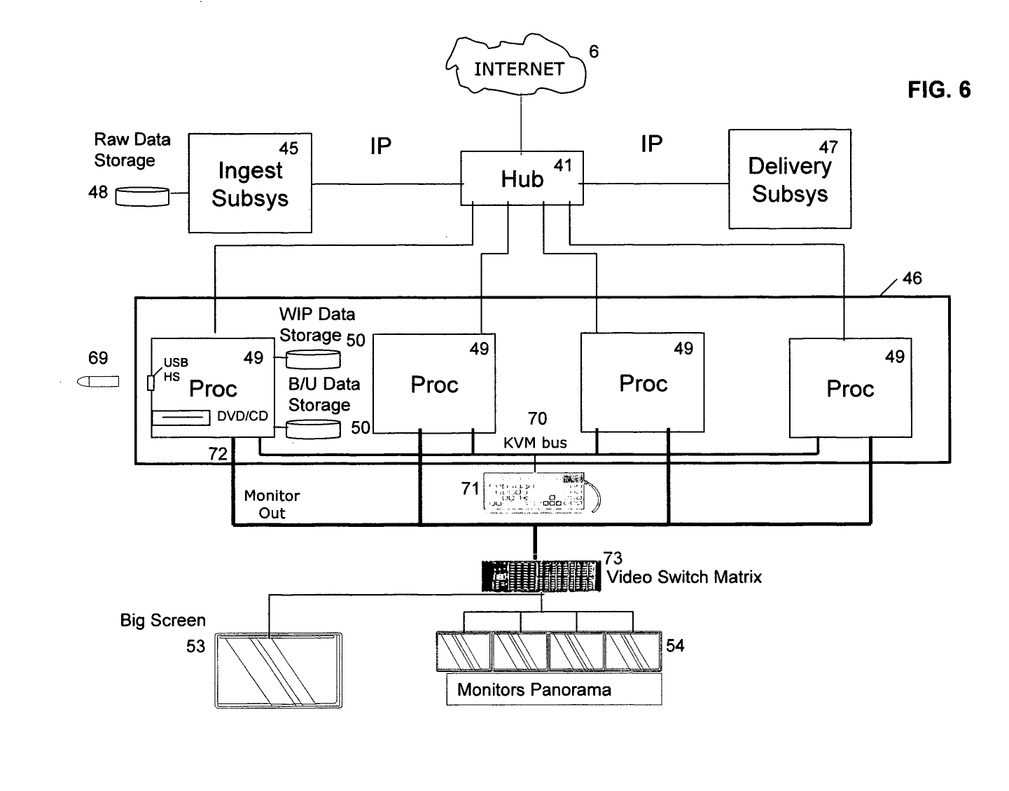

FIG. 6 is a diagram of a content management subsystem according to an example embodiment of the present invention. A content management subsystem 46 according to embodiments of the present invention may contain at least one processor 49. Each processor 49 may have an interface to a keyboard, video, mouse (KVM) bus 70 that is connected to a KVM switch 71. Each processor 49 also includes a monitor output 72 that provides output to be received by a video switch matrix 73 for routing and displaying on one or more large screen monitors 53 and/or panoramic monitors 54. One or more administrators at the NOC 1 may control the KVM switch 71 to route the output from each processor 49 to the desired large screen monitors 53 and/or panoramic monitors 54 through the video switch matrix 73. Output from different processors 49 may be displayed on different panoramic monitors 54. Further, the output from one processor 49 may be displayed on the large monitor 53, or outputs from different monitors displayed on the large monitor 53 in the form of different windows in different portions of the display. Moreover, the large big screen monitor 53 may be used to display the current content being distributed to a user(s).

Each processor 49 may contain software that aids in the content management functions such as, for example, video editing software such as adobe video and avid, encoder software, voice over Internet Protocol (VOIP) application software, audio mixer software, etc. Moreover, each processor 49 may be connected to one or more storage devices 50 for storing work in progress (WIP) data and back-up (B/U) data storage. In addition, each processor 49 may contain devices/logic such as a USB interface, DVD/CD player, IEEE 1394 Fire wire interface, etc.

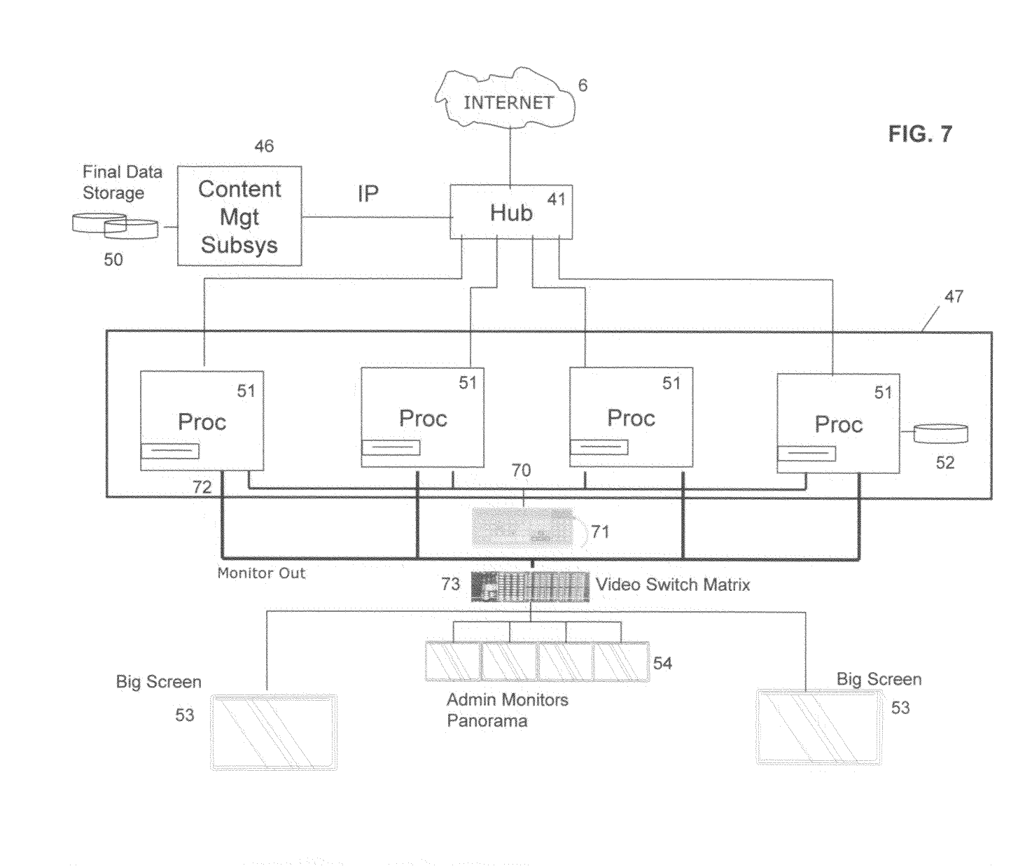

FIG. 7 is a diagram of a delivery management subsystem according to an example embodiment of the present invention. A delivery management subsystem 47 according to embodiments of the present invention may include at least one processor 51. Each processor 51 may have an interface to the KVM bus 70 that is connected to the KVM switch 71. Each processor 51 also includes a monitor output 72 that provides output to be received by the video switch matrix 73 for routing and display on one or more large screen monitors 53 and/or panoramic monitors 54. One or more administrators at the NOC 1 may control the KVM switch 71 to route the output from each processor 51 to the desired large screen monitors 53 and/or panoramic monitors 54 through the video switch matrix 73. Output from different processors 51 may be displayed on different panoramic monitors 54. Further, the output from one processor 51 may be displayed on the large monitor 53, or outputs from different monitors displayed on the large monitor 53 in the form of different windows in different portions of the display.

Each processor 51 may contain software that aids in the delivery management functions such as, for example, uplink monitor software, downlink monitor software, hub configuration/monitor software, video mixer software, space monitor software, router configuration software, NOC SNMPvue software, email application software, Windows Office applications software, Website Management System (WMS) software, Firewall Management System (FMS) software, web server software, email server software, Private Branch Exchange (PBX) window software, email server software, etc. Moreover, each processor 51 may be connected to one or more storage devices 52 for storing finished data. In addition, each processor 51 may contain devices such as a USB interface, DVD/CD player, IEEE 1394 Fire wire interface, etc.

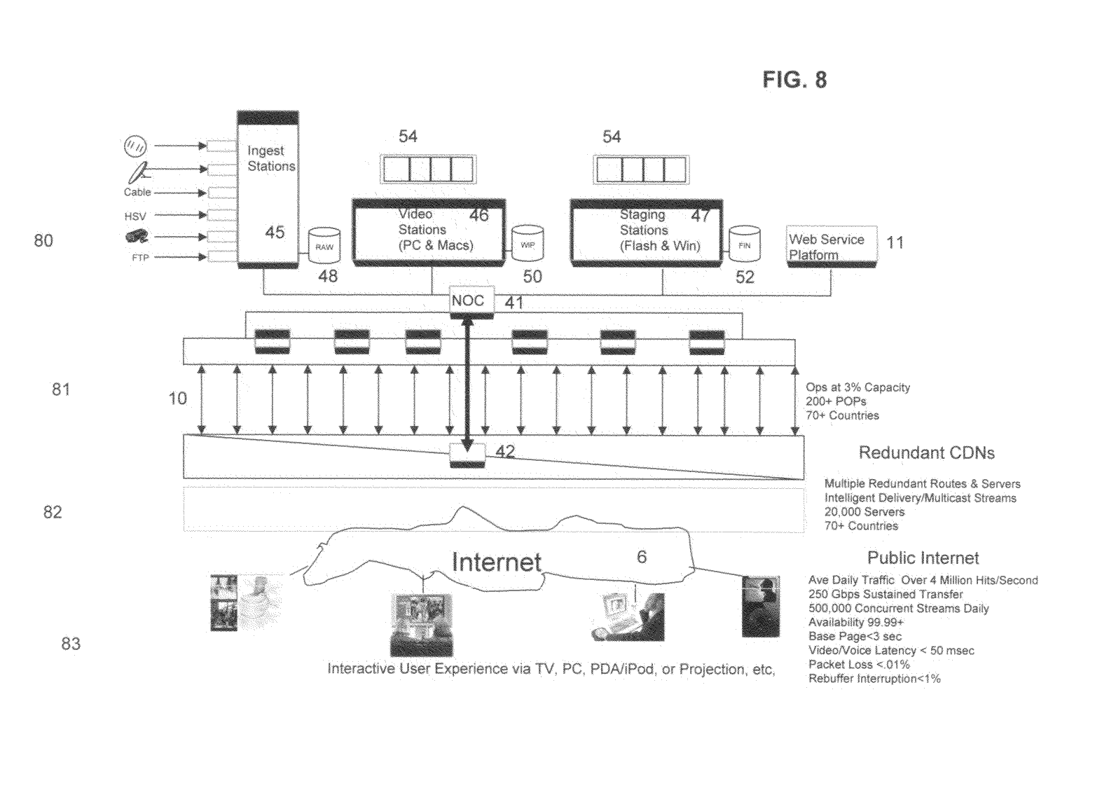

FIG. 8 shows a diagram of an IP-based television interactive broadcast multi-layered architecture according to an example embodiment of the present invention. This architecture may include a video layer 80, a transit layer 81, a content delivery network (CDN) layer 82, and a delivery layer 83. The video layer 80 includes the NOC 1 discussed previously, i.e., the first subsystem (ingest stations) 45, the second subsystem (video stations) 46, and the third subsystem (staging stations) 47. The NOC 1 may communicate with a web service platform 11. As noted, the video layer 80 according to embodiments of the present invention provides rapid scalability processors and storage. The processors may be operated to produce a desired bandwidth, for example, a bandwidth maximum of 25% of system capacity. The video layer 80 is interconnected to the transit layer 81 via one or more hubs 41.

The transit layer 81 may include one or more hubs 41 that are interconnected to the one or more CDNs 10. According to embodiments of the present invention, there may be several content delivery networks 10. Further, each CDN may be operated at various performance levels, for example, at 3% capacity, over hundreds of Post Office Protocols (POPS), and in several countries all over the world.

The CDN layer 82 includes one or more routers/servers 42 that may be interconnected with the one or more content delivery networks 10. There may be multiple redundant routers and servers providing intelligent delivery of content in multicast streams to thousands of servers in multiple countries.

The delivery layer 83 includes one or more networks that carry the content to users, such as the Internet 6. The delivery layer 83 provides users with an interactive experience via many different methods such as, for example, a television, a PC, a Personal Digital Assistant (PDA), a projection monitor, an iPod, etc. The delivery layer 83 according to embodiments of the present invention may have different characteristics/performance such as, for example, over 4 million hits/second on average daily, 250 Gbps sustained transfer, 500,000 concurrent steams daily, 99.99+% availability, a base page<3 sec, a video/voice latency<50 msec, a packet loss<0.1%, a rebuffer interruption<1%, etc.

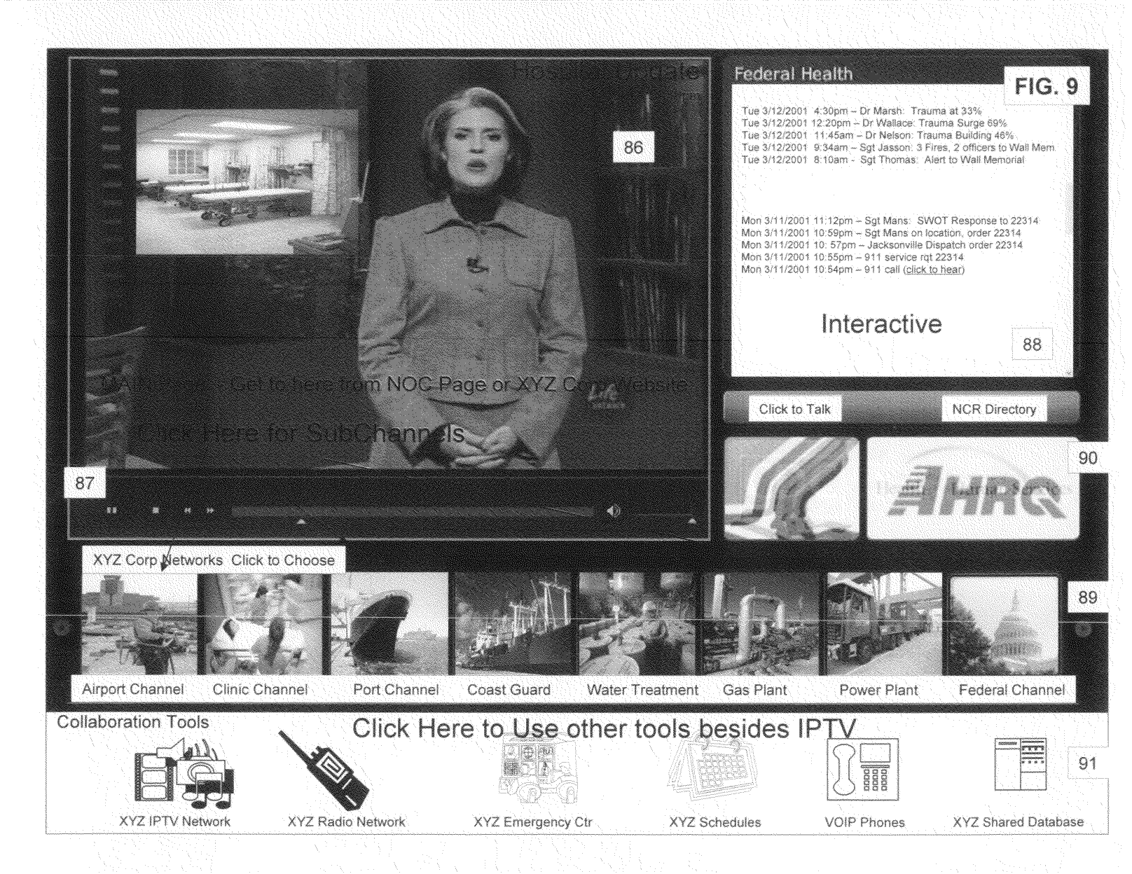

FIG. 9 is a diagram of a first example screen on an interactive GUI of a user's computer in an IP-based television interactive broadcast system according to an example embodiment of the present invention. This screen is an example of what a user may see after receiving content. This screen/webpage may be created and sent by the NOC 1 in response to a request by the user for content, e.g., on-demand content, broadcast content, etc. The interactive GUI combines multiple video windows having TV quality with additional 2-way video windows. The TV quality windows and the video windows are integrated with interactive modules. The interactive modules comprise functions supporting 2-way exchanges such as, for example, voice, chat, polls, surveys, guest books, database interactions (forms, queries, reports), exams, quizzes, tests, whiteboards, desktop share, file share, animated image maps, or other 2-way exchanges.

In this example embodiment, the user is receiving/viewing content related to XYZ Corporation. The screen may consist of several different windows, each with different type of data. For example, there may be a main window 86 that is typically larger than other windows displaying content that the user has selected for viewing. There may also be a section 87 displayed on the screen that allows the user to control the playing of content as well as the volume. There may also be an interactive window 88 allowing the user to interactively chat with other users regarding the content in the main window or any other subject.

Moreover, there may be a section containing one or more icons or pictures 89, selectable by the user to change the channel being accessed and viewed by the user. In addition, according to embodiments of the present invention, a user may access a conference bridge that allows the user to interact with people in the main window, such as the woman, in real time. There may also be windows or portions of the screen 90 that may display content such as advertisements, announcements, alerts, sponsors, etc. This content may be rotated and displayed sequentially one at a time. The screen may also include a section 91 of icons that are selectable by the user to access other tools such as, for example, the XYZ company IP TV Network, the XYZ company radio network, the XYZ company emergency center, the XYZ company schedules, a voice over IP (VOIP) telephone system, the XYZ company shared database, etc. Upon selection of one of these utilities, a window, for example the interactive window 88, may be changed to content related to the selected icon. For example, if the VOIP icon is selected, the interactive window 88 may change to represent a keypad of a phone allowing dialing of a number, or access to a conference bridge as mentioned previously. Thus, according to embodiments of the present invention, a screen or webpage may displayed at a user's site that provides the user with varied content and multiple channels as well as varied options for selecting other channels or content or other tools or information, and further allows for interactive communication with the user.

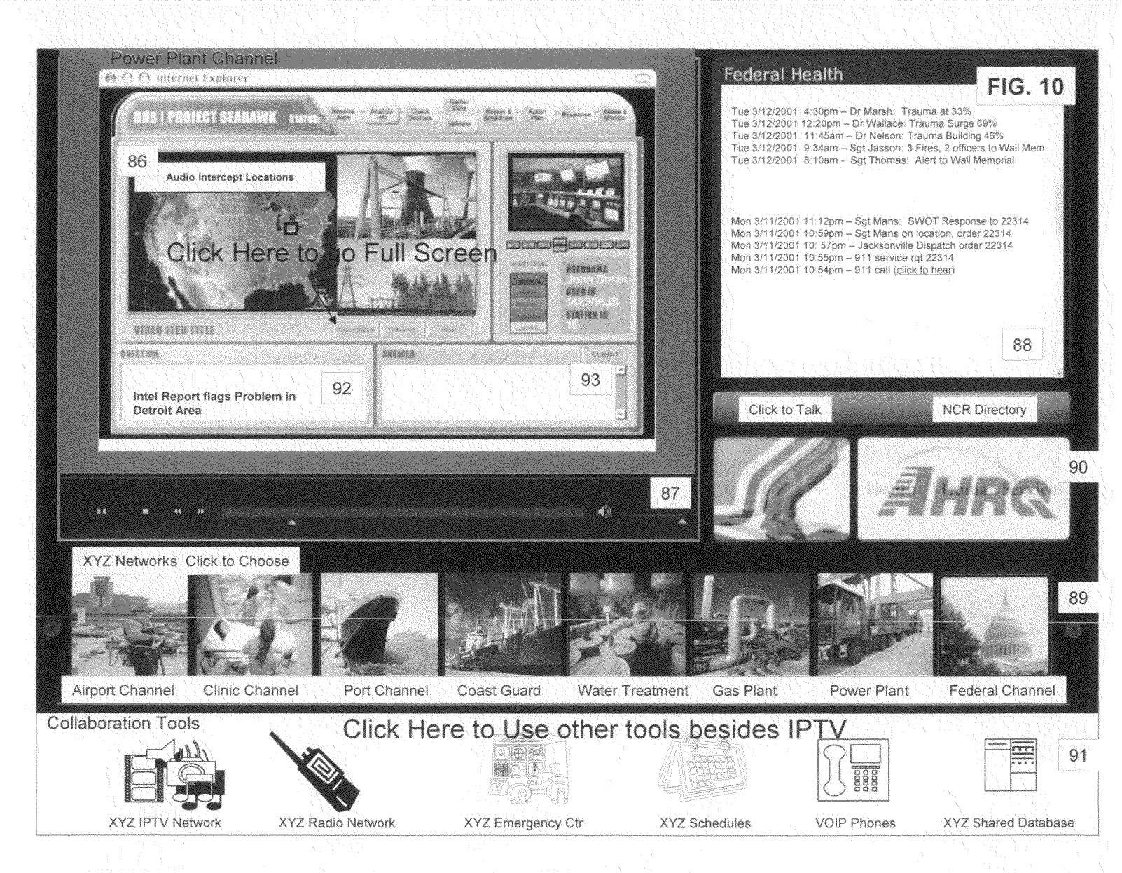

FIG. 10 is a diagram of a second example screen on a GUI of a user's computer in an IP-based television interactive broadcast system according to an example embodiment of the present invention. In this example embodiment, a power plant channel has been selected by the user. The main screen 86 may be composed of several screens displaying multiple types of content simultaneously to the user. Further, in this example embodiment, a first area 92 and a second area 93 may be provided where the user can enter questions and receive answers to these questions interactively.

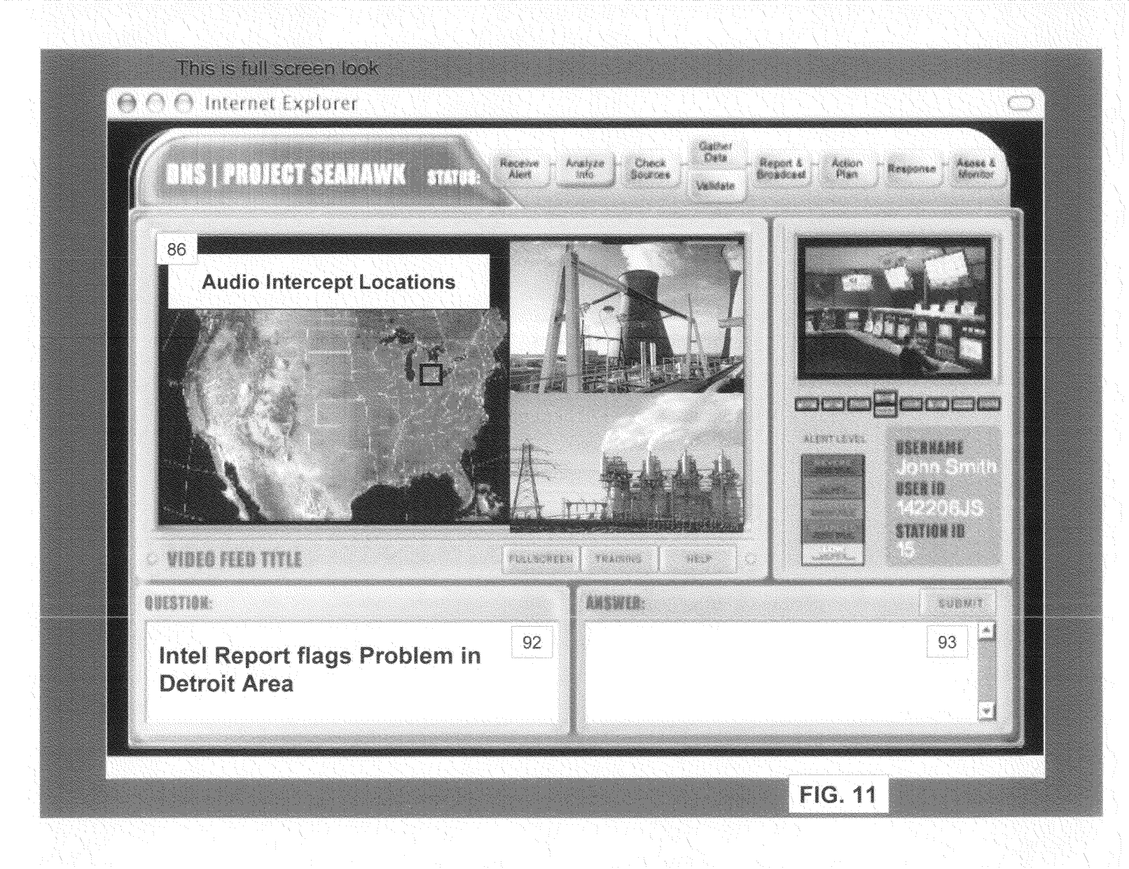

FIG. 11 is a diagram of a third example screen on a GUI of a user's computer in an IP-based television interactive broadcast system according to an example embodiment of the present invention. In this example embodiment, the majority of the screen 86 is used to display the multiple images of different content shown in FIG. 10 as well as the question and answer areas 92, 93 at the bottom.

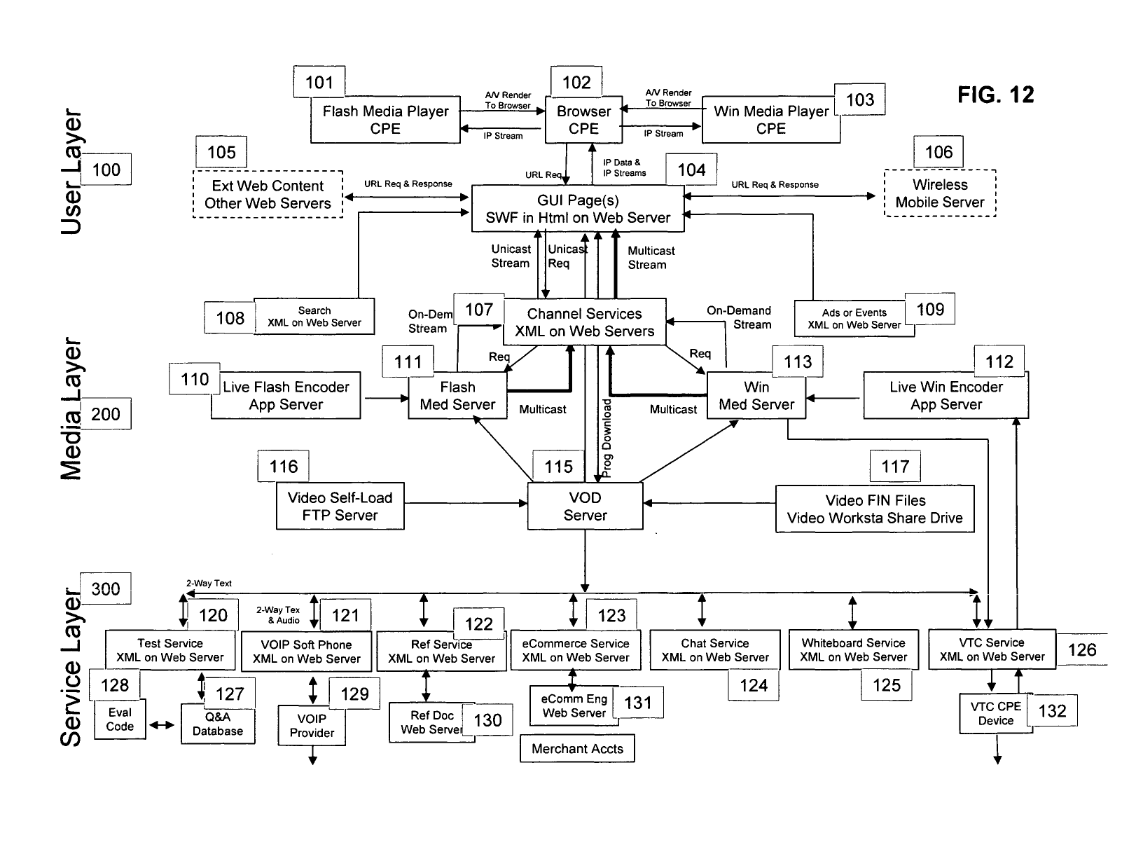

FIG. 12 is a functional block diagram of an IP-based television interactive broadcast system according to an example embodiment of the present invention. The diagram illustrates functional blocks and the layers that they are associated. The functional blocks may be associated with one of a user layer 100, a media layer 200, or a service layer 300. The user layer 100 may include a flash media player 101, a browser 102 and a Win media player 103 that are all Customer Premise Equipment (CPE) and reside at a customer site or PC. The flash media player 101 may send audio/video render information to the browser 102 and receive an IP stream from the browser 102. The Win media player 103 may also send audio/video render information to the browser 102 and receive an IP stream from the browser 102.

The user layer 100 may also include one or more GUI pages 104 in Macromedia Flash (SWF) or hypertext markup language (HTML) on a web server. In response to a URL request from the browser 102, these pages 104 may be transferred to the browser 102 in IP data and/or IP streams. The URL requests and appropriate responses may be transmitted between the Web Server and other web servers 105 with external web content as well as wireless mobile servers 106. The GUI page function resides in the NOC 1.

The media layer 200 may include channel services 107 in extensible markup language (XML) on web servers. The channel services 107 may receive unicast and multicast requests from the GUI page web server 104 and in response send an appropriate unicast stream or multicast stream to the GUI web server 104. The media layer 200 may also include a search function 108 and an advertisements or an events function 109, both of which may be in XML on a web server and that send information to the GUI page web server 104.

The media layer 200 may further include a live flash encoder function 110 that may reside on an application server and that may feed into a flash media server 11. In response to receiving a request from the channels services 107, the flash media server 111 may send an on-demand stream or multicast stream to the channel services. Similarly, the media layer 200 may include a live Win encoder function 112 that may reside on an application server and that may feed into a Win media server 113. In response to receiving a request from the channels services 107, the Win media server 113 may send an on-demand stream or multicast stream to the channel services 107.

The media layer 200 may also include a video-on-demand (VOD) server 115. The VOD server 115 may receive self-loaded video content from an FTP server 116 and video content files that are finished processing and ready for distribution from a video workstation share drive 117. The VOD server 115 may transfer the received content to the flash media server 111 and the Win media server 113. The functions at the media layer 20 preferably are performed in the NOC 1.

The service layer 300 may include functions related to the various types of content that may be sent from content owners/producers. These functions may include, for example, a test service 120, a VOIP soft phone 121, a reference service 122, an eCommerce service 123, a chat service 124, a whiteboard service 125, a video teleconferencing (VTC) service 126, etc. These services/functions may exist in XML and may reside on one or more web servers. These services/functions may also communicate with the VOD server 115. The test service 120 may receive/transmit information with a question and answer database 127 that communicates with evaluation code 128. Further, the web server 121 providing the VOIP soft phone may communicate with a VOIP provider 129, and the web server 122 providing the reference service may communicate with a reference document web server 130. In addition, the web server providing the eCommerce service 123 may communicate with an eCommerce engine web server 131, and the web server providing the VTC service 126 may communicate with a VTC CPE device 132. The VTC service 126 may communicate with the live Win encoder application server 112 and the Win media server 113.

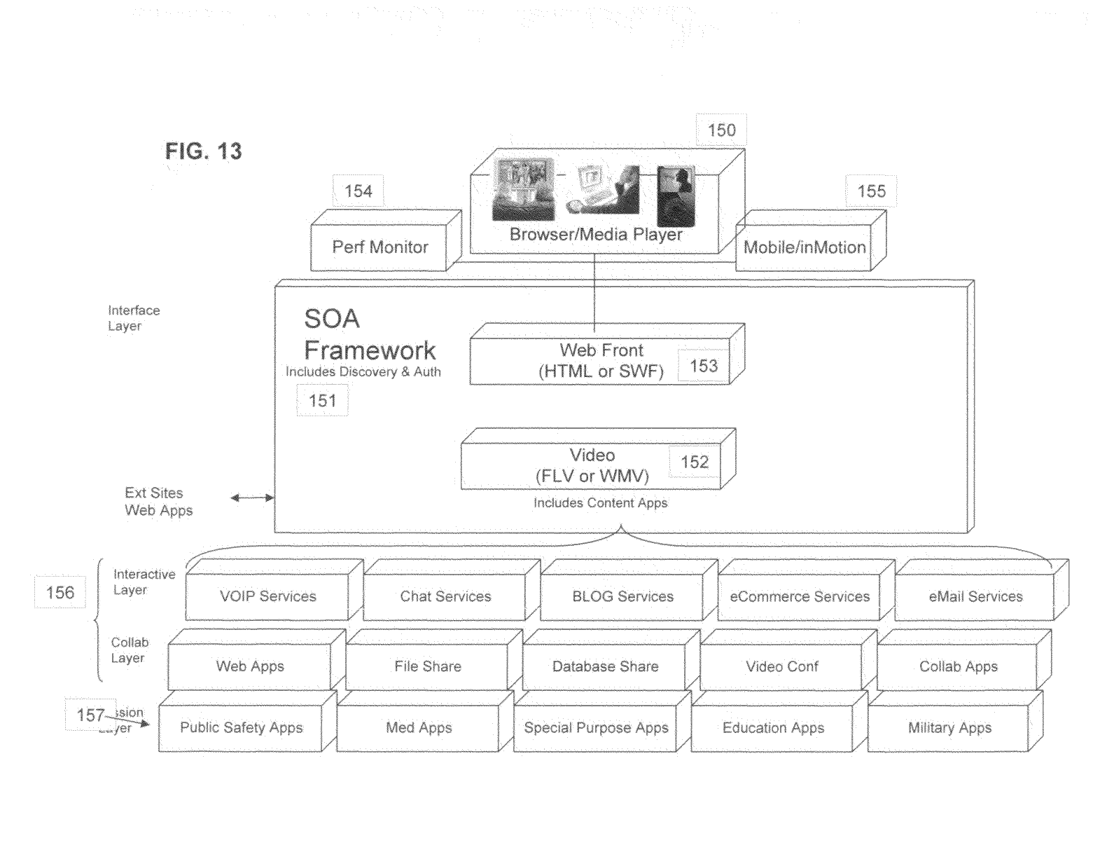

FIG. 13 is a diagram of software components in an IP-based television interactive broadcast system according to an example embodiment of the present invention. These software components may primarily reside in processors/servers at the NOC 1, and may include, for example, a browser/media player 150 and service-oriented architecture (SOA) framework software 151, at an interface layer, and that may include video content application software 152. The SOA framework 151 may also include web front software 153 that may exist in HTML or SWF. Performance monitor software 154 may monitor traffic of the NOC 1, and may be located external to the NOC 1. Moreover, a mobile/in Motion application 155 may be used to deliver channels of content to mobile devices through a server/processor.

The video content application software 152 may support the content displayed on the big screen monitor 53. Further, a plurality of software modules 156 may enable the one or more icons or pictures 89, selectable by the user to change the channel being accessed and viewed by the user. These software modules 156 may include, for example, VOIP services, chat services, BLOG services, eCommerce services, email services, all at an interactive layer, and web applications, file share, database share, video conference, and collaboration applications, all at a collaboration layer. In addition, customized applications 157 may exist such as, for example, public safety applications, media applications, special purpose applications, education applications, military applications, etc.

Embodiments according to the present invention provide several advantages over current systems. For example, immediate cost reduction n existing operations, ability to pull from and reach new locations, integrated content management, policy, and workflow capabilities, centralized operations and global collaboration enablement, flexible hub spoke architecture with access controlled sharing, sharing and distribution (push/pull) over multiple paths, ability to release to head ends and other broadcast facilities, ability to trial new content, ability to trial new locations, disaster recovery/continuity of operations, lower cost migration to high definition, opportunity to migrate to interactive IBTV, etc.

Moreover, embodiments according to the present invention may enhance the amount of content and quality of content that can be delivered to the home by using the off peak (unused bandwidth) to push content to the subscriber (home or business). The entire platform is scalable and can easily grow to accommodate more channels. Further, embodiments according to the present invention are easy for content owners to use and deliver TV quality viewing experiences over IP, which can be viewed from any IP device such as, for example, a computer, TV, portable phone, PDA, etc. Moreover, embodiments according to the present invention include systems able to sense the bandwidth and device available from the IP session data and adjust the streams accordingly.

It is noted that the foregoing examples have been provided merely for the purpose of explanation and are in no way to be construed as limiting of the present invention. While the present invention has been described with reference to a preferred embodiment, it is understood that the words that have been used herein are words of description and illustration, rather than words of limitation. Changes may be made within the purview of the appended claims, as presently stated and as amended, without departing from the scope and spirit of the present invention in its aspects. Although the present invention has been described herein with reference to particular methods, materials, and embodiments, the present invention is not intended to be limited to the particulars disclosed herein, rather, the present invention extends to all functionally equivalent structures, methods and uses, such as are within the scope of the appended claims.

What is claimed is:

1. An IP-based television interactive broadcast system comprising:
a network operations center (NOC);
at least one content provider;
at least one private network, the private network being operatively connected to the NOC;
a public network, the private network being operatively connected to the public network; and
at least one user device, each at least one user device being capable of accessing the public network using an interactive graphical user interface (GUI),
wherein the NOC receives requests for content from the at least one user device, receives raw content from the at least one content provider, processes the received raw content, delivers the processed content to the at least one user device over the private network and the public network, and enables each al: least one user to interact with content via the respective at least one user device that embodies the interactive GUI.

2. The system according to claim 1, the NOC further comprising a first subsystem for receiving the raw content, a second subsystem for processing the raw content, and a third subsystem for delivering the processed content.

3. The system according to claim 2, the second subsystem processing the raw content by performing at least one of encoding the raw content, editing the raw content, inserting special effects into the raw content, or inserting graphics into the raw content.

4. The system according to claim 2, the third subsystem having the capability to stack multiple streaming files into a playlist, store all of the processed content from the second subsystem, broadcast the playlist, control access to the playlist, and manage the delivery of the streaming files in one or more channels to worldwide audiences, the worldwide audiences being capable of interacting with the content and sources of the content.

5. The system according to claim 4, wherein the interacting is managed by the third subsystem.

6. The system according to claim 2, wherein the processing further comprises integrating interactive modules into a web front.

7. The system according to claim 1, wherein the at least one content provider provides at least one of pre-recorded raw content or live raw content to the NOC and has the capability for interaction with the at least one user.

8. The system according to claim 1, wherein the raw content is received from multiple said content providers located in multiple locations.

9. The system according to claim 8, wherein each of the at least one user is capable of interacting with each of the multiple locations.

10. The system according to claim 1, wherein the at least one content provider comprises at least one of a production center, a head end entity, a media outlet entity, a live content generation entity, or a pre-recorded content generation entity.

11. The system according to claim 1, wherein the NOC comprises a plurality of processors/servers, the number of processors/servers being scalable.

12. The system according to claim 1, wherein the at least one private network comprises at least one content delivery network (CDN).

13. The system according to claim 1, wherein the public network comprises the Internet, the NOC broadcasting many unlimited channels of content over the Internet within a single IP Internet session, each of the at least one user being capable of interacting with the content or any other at least one user viewing any of the channels.

14. The system according to claim 1, wherein the interactive GUI combines multiple video windows having TV quality with additional 2-way video windows, the TV quality windows and the video windows being integrated with interactive modules.

15. The system according to claim 14, where the interactive modules comprise functions supporting at least one of voice, chat, polls, surveys, guest books, database interactions (forms, queries, reports), exams, quizzes, tests, whiteboards, desktop share, file share, animated image maps, or other 2-way exchanges.

16. A method for IP-based television interactive broadcasting to worldwide audiences comprising:
receiving content from at least one content provider, the content being received by at least one device capable of receiving various types of content including pre-recorded content and live content;
processing the received content, the processing being performed by at least one first processor, the at least one first processor capable of encoding the content, editing the content, inserting special effects into the content, inserting advertisements into the content, inserting links to other content into the content, inserting interactive modules into the content, and inserting graphics into the content; and
delivering the processed content to user devices using a private network and a public network, the delivering being performed by at least one second processor, the at least one second processor capable of stacking multiple streaming files into a playlist, storing all of the processed content, broadcasting the processed content, controlling access to the processed content, and managing the delivery of the processed content in streams/channels to user devices worldwide interactively.

17. The method according to claim 16, wherein the receiving further comprises self-loading of the content from the at least one content provider allowing quick checkout of the received content, quality control of the received content and movement of the received content directly to the at least one first processor for processing.

18. The method according to claim 16, wherein the at least one device comprises at least one of an analog-to digital converter, a tuner/streamer, a high speed video receiver, a DVD/CD device, or a USB device.

19. The method according to claim 16, further comprising displaying the received content and the content being processed on a plurality of monitors, each monitor capable of displaying the same or different content as selected by an administrator.

20. The method according to claim 16, wherein the private network comprises a content delivery network (CDN) and the public network comprises the Internet, the processed content being delivered comprising a plurality of unlimited channels of content delivered over the Internet within a single IP Internet session.

21. An IP-based television interactive broadcasting network operations center (NOC) comprising:
a first subsystem, the first subsystem receiving and storing raw content arriving from a content generation source;
a second subsystem, the second subsystem comprising at least one first processor for processing the received content, the at least one first processor capable of encoding the content, editing the content, inserting special effects into the content, inserting advertisements into the content, inserting links to other content into the content, and inserting graphics into the content; and
a third subsystem, the third subsystem comprising at least one second processor, the at least one second processor capable of stacking multiple streaming files into a playlist, storing all of the processed content from the second subsystem, broadcasting the processed content, controlling access to the processed content, and managing the delivery of the processed content in streams/channels to worldwide audiences.

22. The NOC according to claim 21, further comprising at least one first storage device operatively connected to the at least one first processor and at least one second storage device operatively connected to the at least one second processor.

23. The NOC according to claim 21, further comprising at least one set of a plurality of panoramic monitors, each monitor being capable of displaying the received content or the content being processed, each monitor also capable of displaying the same or different content as selected by an administrator.

24. The NOC according to claim 18, further comprising at least one big screen monitor, each at least one big screen monitor displaying of the received content or content being processed.

25. The NOC according to claim 18, the second subsystem and the third subsystem being scalable by adjusting the number of the at least one first processor and the at least one second processor, respectively.
